(19) United States
(12) Patent Application Publication
(10) Pub. No.: US 2004/0161491 A1
(43) Pub. Date: Aug. 19, 2004

(54) Method and composition for improving the flavor stability of malt beverages

(76) Inventors: Patrick L. Ting, Brookfield, WI (US); Lance T. Lusk, Milwaukee, WI (US); Jay R. Refling, Greenfield, WI (US); John R. Seabrooks, Richfield, WI (US); David S. Ryder, Mequon, WI (US)

Correspondence Address: QUARLES & BRADY LLP, 411 E. WISCONSIN AVENUE, SUITE 2040, MILWAUKEE, WI, 53202-4497, US

(21) Appl. No.: 10/367,044

(22) Filed: Feb. 14, 2003

(51) Int. Cl. C12C 11/00

(52) U.S. Cl. 426/11

(57) ABSTRACT

Disclosed are methods and compositions for reducing staling that develops during extended storage of fermented malt beverages, beverages, foodstuffs, and cosmetics. In one method, hop solids are extracted with aqueous C₁-C₆ alcohol to create an extract which is added to wort, the wort is boiled, and thereafter fermented to form a beverage. In another method, hop solids are extracted with aqueous C₁-C₆ alcohol followed by a mixture of 25% to 75% water and 25% to 75% of C₁-C₆ alcohol to create an extract, and the extract is added before or after fermentation or directly to a fermented beverage, beverages, foodstuffs, and cosmetics. In another method, hops are extracted with a mixture of 25% to 75% water and 25% to 75% of C₁-C₆ alcohol to create an extract, and the extract is added in wort, before or after wort boiling, the wort is boiled and thereafter fermented to form a beverage.

### CROSS REFERENCES To RELATED APPLICATIONS

Not applicable.

### STATEMENT REGARDING FEDERALLY SPONSORED RESEARCH

Not applicable.

### BACKGROUND OF THE INVENTION

1. Field of the Invention

The present invention is directed to methods and compositions for improving the flavor stability of malt beverages. More particularly, the invention is directed to methods and compositions for reducing or eliminating stale off-flavors that develop during extended storage of malt beverages.

2. Description of the Related Art

In the production of fermented malt beverages such as beer and ale, an extract of barley malt, with or without other grains such as rice or corn, is boiled with hops or hop extracts, cooled, and then subjected to the fermentative action of yeast. The warm water used to extract the malt allows the action of several enzymes in the malt to hydrolyze the starch in the barley to fermentable sugar, which is acted on by the yeast to produce the alcohol in the fermented malt beverage.

The malt, which may be a blend of malts, is ground and mixed with warm water in large tubs and mashed until it forms a thick malt mash. Various enzymes convert the starches into fermentable sugars. Various brewing “adjuncts” such as corn, rice, sugar and syrups can be used and are added to the malt or separately mixed with samples of the malt, and the malt converts raw starches in the adjuncts to fermentable sugars.

A liquid, termed the “wort”, is removed from the spent grains and introduced into a brewing kettle. The wort is boiled for a period of time in the brew kettle. Hops or hop extracts may be added at various stages of the boiling process, depending on the flavor profile or nature of the final product that is sought. Traditionally hops are added either early, middle, late or a combination of the three times during wort boiling. Wort boiling, among other things, inactivates the remaining enzymes from the mashing process, extracts desirable hop constituents, and sterilizes the wort. After boiling, the wort is cooled and the solids, or “trub”, is removed.

Fermentation is initiated when the wort is pitched with the proper amount of a yeast culture. After a period of time, fermentation is established and proceeds at an accelerated rate. Fermentation typically proceeds for a number of days. During this period, the wort temperature must be controlled, since the fermentation process causes the temperature of the wort to rise. Once the yeast has metabolized fermentable ingredients in the wort, it settles to the bottom as one example and is subsequently recovered and recycled for use in pitching other brews. The fermented wort (often termed “green beer”) is drawn off for storage in a cold room tank (often termed “ruh”) where its temperature is lowered to about 0″-5° C.

The “ruh” beer may be allowed to remain in the ruh tank for completion of the maturation process, or it may be transferred into a separate maturation tank upon further settling of any remaining yeast and other solids. The beer may be allowed to age from days to months so that the beer clarifies and its flavor develops. Upon maturation, the beer generally is filtered to remove the yeasts and other solids. Then, depending on the form of packaging, the beer may be pasteurized. (In the case of the Cold-filtered “draft” beers, a microfiltration system is used to remove organisms, thereby obviating the pasteurization step.) After packaging, the beer is ready for shipment to the consumer.

Malt beverages, especially beer, possess attributes, such as foam, flavor and clarity, that are discernable by the consumer: Of course, flavor is a key factor in the quality of a malt beverage. It is important that a beer retains its original, fresh flavor and character during distribution and storage. This is called the flavor stability or shelf-life of beer. However, shortened shelf-life due to oxidation resulting in the development of off-flavors has been a problem for beer manufacturers and distributors. The flavor staling of beer is one type of off-flavor formation. The stale off-flavors that are produced during extended storage have been expressed as papery, cardboard-like and oxidized. The rate at which aged or stale off-flavor forms in beer, has presented a problem to brewers for many years. The environment in which beer is stored is critical for minimizing staling. If the beer is stored at cooler temperatures, the staling process will only occur slowly; and of course, raising the temperature will increase the rate of staling. However, with the trend toward an increasing number of international beer brands, distribution distances increase, and the ability to carefully control the storage environment for beer is compromised. Therefore, the problem of beer flavor staling is ever more evident as brewers strive to assure the quality of their product in the face of increased transportation and storage times in the global market.

The beer staling mechanism has been described as very complex relative to other off-flavor problems in that flavor perception represents the net effect of a series of chemical changes to the flavor impact components of beer. In “Shelf Life Analysis of Beer Using an Automated Lag-Time EPR System”, Spectroscopy 16(12), pgs. 17-19, December 2001, it is noted that the “cardboard” like flavor that occurs in stale beer is thought to arise from the “free radical” mediated oxidation of various constituents in beer. The characteristic odor and taste are believed to be caused by decomposition products from the free radical process. It is reported that these “off-flavor” products can be detected by the consumer in beer even at very low concentrations.

In “Flavour Impact of Aged Beers” from the Proceedings of the 25th Convention of the Institute of Brewing—Asia Pacific Section, Evans et al. report that the formation of aldehydes in beer results in flavor change during storage, and that two distinct groups of flavor active aldehydes appear to cause off flavors. Off flavors result from aldehydes that appear to be derived from the oxidative degradation of unsaturated fatty acids, e.g. 2-trans-nonenal, and from aldehydes that are derived from the non-oxidative Strecker degradation of amino acids, e.g. phenylacetaldehyde. While it is uncertain which of these and other related mechanisms predominate, the role of aldehyde formation is clearly implicated as a contributor towards the formation of stale flavor in beer.

U.S. Pat. No. 4,110,480 also reports that stale flavors in beer involve the oxidation of long-chain fatty acids and the subsequent degradation to aldehydes such as 2-trans-nonenal. It is further stated that these processes are believed to occur through enzyme mediated oxidation of unsaturated fatty acids, such as linoleic acid, with eventual oxidative or non-oxidative scission of the carbon chain to give flavor-active compounds having carbon lengths of 6 to 12. This patent teaches that staling in beer can be eliminated by, prior to extracting the ground malt with hot water, the malt is contacted with an organic substance, such as methanol, ethanol, propanol, butanol, isoamyl alcohol, phenylethanol, dimethylsulfoxide, acetic acid and propylene glycol, to reduce the amount of precursors of 2-trans-nonenal present in the malt.

Other methods for improving the flavor stability of malt beverages have been proposed. In U.S. Pat. No. 5,460,836, it is suggested that extracting and removing lipids from malt using subcritical or supercritical carbon dioxide can improve the flavor stability of malt beverages. In U.S. Pat. No. 4,911,936, it is proposed that adding yeast to a fermented beer can stabilize the flavor of malt beverages. U.S. Pat. No. 6,372,269 teaches that yeast cells that produce reductase enzymes can be added to wort during the beer making process to stabilize the flavor of beer. In “Potential Antioxidants in Beer Assessed by ESR Spin Trapping”, J. Agric. Food Chem. 2000, 48, 3106-3111, July 2000, it is reported that sulfite, phenolic compounds, thiols and ascorbic acid were tested as potential antioxidants to stabilize the flavor of beer. These patents and all other patents and publications cited herein are incorporated herein by reference.

Traditionally, those wishing to investigate the flavor stability of beer have used human sensory analysis for measuring the off flavors that may develop in beer. However, because oxidative degradation has been found to be one cause of stale flavors in beer, analytical chemical methods have been developed to evaluate the flavor stability of beer by evaluating the oxidation resistance (anti-oxidants) of beer. In U.S. Pat. No. 5,811,305, there is described an analytical method for evaluating flavor stability of a fermented alcoholic beverage using electron spin resonance. By investigating the formation behavior of active oxygen (or free radicals) at the start of oxidative deterioration, it is possible to accurately evaluate and predict the flavor stability of a fermented alcoholic beverage at the time it becomes a finished product.

Hops are one of the major brewing raw materials and are known for adding characteristics of aroma and flavor, bitterness, foam, and anti-microbial activity to fermented malt beverages. Hops can be extracted by supercritical/liquid CO₂ or organic solvents to produce hop extracts and remaining hop solids. Hop extracts as supercritical/liquid CO₂, ethanol (95% ethanol), and hexane are commercially available. The hop extract consists of alpha-acids, beta-acids, and hop oil fraction. The alpha-acids are converted into iso-alpha-acids during wort boiling to contribute bitterness to fermented malt beverages. The hop oil fraction provides some aroma to fermented malt beverages. U.S. Pat. Nos. 5,783,235 and 5,972,411 report the application of the remaining hop solids for flavoring of the fermented malt beverages.

Even though many publications, for example, in “The Role of Malt and Hop Polyphenols in Beer Quality, Flavor and Haze Stability” Journal of the Institute of Brewing, vol. 108, No. 1, p. 78-85, 2002, report that malt polyphenols, particularly hop polyphenols, in the course of wort boiling, improved reducing activity value and the carbonyls content in fresh and stored beer and various methods such as reducing the oxygen level in the packages have been proposed for improving the flavor stability of malt beverages, there is still a need for a practical method for improving the flavor stability of malt beverages. In particular, there is a need for practical methods and effective compositions for reducing or eliminating the precursors of free radicals that develop during the brewing process and extended storage of malt beverages.

### SUMMARY OF THE INVENTION

The present invention satisfies the foregoing needs by providing methods and compositions for improving the flavor stability of a fermented malt beverage. The methods and compositions reduce or eliminate the precursors of free radicals as well as stale off-flavors that develop during brewing process and extended storage of malt beverages.

In a first aspect, the present invention provides a method for improving the flavor stability of a fermented malt beverage wherein natural antioxidants present in hop solids are effectively fractionated such as by a mixture of water and a C₁-C₆ monohydric or polyhydric alcohol to create a hop solids extract, and the resulting hop solids extract is added to wort boiling or prior to fermentation. Without intending to be bound by theory, it is believed that the natural antioxidants in the hop solids extract in the fermented malt beverage serve to reduce the free radical mediated oxidation of various constituents in the beverage that leads to stale off flavors. The hop solids extract gives the benefits of flavor and flavor stability improvements.

In a second aspect, the present invention provides a method for improving the flavor stability of a fermented malt beverage wherein hop solids are extracted with a first mixture of water and a C₁-C₆ monohydric or polyhydric alcohol to remove residual α-acids, resinous substances and pigments, the extracted hop solids are recovered from the first mixture, the natural antioxidants present in the extracted hop solids are effectively fractionated such as by using a second mixture of water and a C₁-C₆ monohydric or polyhydric alcohol to create a selective hop solids extract, and the selective hop solids extract is added after fermentation or to a fermented malt beverage. Without intending to be bound by theory, it is believed that the natural antioxidants present in the hop solids extract in the fermented malt beverage serve to reduce the free radical mediated oxidation of various constituents in the beverage that leads to stale off flavors. Because the extract contains a minimum or no alpha-acids/iso-alpha-acids, the hop solids extract gives the benefits of flavor and flavor stability improvements and light stability.

In a third aspect, the present invention provides a method for improving the flavor stability of a fermented malt beverage wherein hop solids are extracted such as with a first mixture of water and a C₁-C₆ monohydric or polyhydric alcohol removing residual alpha-acids, resinous substances and pigments, the extracted hop solids are recovered from the first mixture, the natural antioxidants present in the extracted hop solids are further fractionated such as with a second mixture of water and a C₁-C₆ monohydric or polyhydric alcohol to create a selective hop solids extract, and the selective hop solids extract is added to wort boiling or prior to fermentation. Without intending to be bound by theory, it is believed that the natural antioxidants from the selective hop solids extract in the fermented malt beverage serve to reduce the free radical mediated oxidation of various constituents in the beverage that leads to stale off flavors. Because the selective extract contains a minimum amount or no alpha-acids/iso-alpha-acids, it can be used for light stable products and improvements of flavor and flavor stability.

In a fourth aspect, the present invention provides a method for improving the flavor stability of a fermented malt beverage wherein hops are extracted for example with a mixture of 25% to 75% water by volume and 25% to 75% of a C₁-C₆ monohydric or polyhydric alcohol by volume to create a hop extract. The hop extract contains both hop soft resins (particularly alpha-acids) and enriched-natural antioxidants. The hop extract is added to wort, prior to or during boiling, the wort is boiled, and the wort is fermented to form a fermented malt beverage. The hop extract used in the kettle boiling has the benefits of protecting against the heat damage (free radical or free radical precursor formation prevented possibly by alpha-acids) of wort in the kettle and improves the flavor stability of finished products (by the natural antioxidants) in addition to contributing to the hop flavor and bitterness of the fermented malt beverage. It is believed that reducing the formation of free radical precursors of wort in the kettle will improve the shelf-life of the finished malt beverage product.

In a fifth aspect, the present invention provides a method for improving the flavor stability of a fermented malt beverage. In this method, an additive consisting essentially of alpha acids and/or alpha acid derivatives is introduced into a wort, and thereafter the wort is fermented to prepare a fermented malt beverage. The alpha-acids or alpha-acid derivatives used in the wort boiling has the benefit of protecting against the heat damage (preventing the formation of free radicals or free radical precursors). It is believed that reducing the formation of free radical precursors of wort boiling will improve the shelf-life of the finished malt beverage product.

In a sixth aspect, the present invention provides a method for reducing the oxidative staling of a food or beverage. In this method, hop solids are extracted with a solvent comprising a C₁-C₆ monohydric or polyhydric alcohol, the hop solids are recovered from the solvent, the recovered hop solids are extracted with a mixture comprising water and a C₁-C₆ monohydric or polyhydric alcohol to create a hop solids extract comprising enriched natural antioxidants, and the hop solids extract is added to a food or beverage.

In a seventh aspect, the present invention provides a method for reducing the oxidative degradation of a cosmetic. In this method, hop solids are extracted with a solvent comprising a C₁-C₆ monohydric or polyhydric alcohol, the hop solids are recovered from the solvent, the recovered hop solids are extracted with a mixture comprising water and a C₁-C₆ monohydric or polyhydric alcohol to create a hop solids extract comprising enriched natural antioxidants, and the hop solids extract is added to a cosmetic.

The free radical theory of beer staling has generally been accepted. According to this theory, radicals of some organic and inorganic compounds support the process of reactions that affect beer staling formation of stale flavor compounds. In the sequence of radical reactions which occur in wort and beer, and which result in the formation of stale flavor carbonyl, antioxidants play an important role, because they can directly or indirectly affect the carbonyl content in beer. Polyphenols have been considered the main natural anti-oxidants in brewing raw materials and beer. Sulfite is usually also considered to prevent the oxidative staling of beer. Sulfite is produced by yeast during fermentation.

Using a combination of EPR and a spin trapping agent, one can quantitatively monitor the free radical formation of a wort sample during autoxidation at 60° C. for three hours. On the other hand, EPR measures a lag time of beer which is force-oxidized at 60° C. for three hours. The lag time is formed by the presence of antioxidants in beer. The antioxidants delay the free radical formation and also improve the shelf-life of beer.

Hops are one of the major brewing raw materials. Hops can be extracted by supercritical/liquid CO₂ (or organic solvents, particularly hexane and ethanol) to produce an extract and a remaining hop solids. The CO₂ hop extract can also be further separated into alpha-acids, beta-acids, and hop oil fraction. Most of these hop products are generally added in wort boiling. During wort boiling, a Maillard reaction (browning reaction) takes place between carbohydrates (reducing sugars) and amino acids or other amine containing compounds to form melanoidins. Some melanoidins may be precursors or initiators of free radicals.

It is thus an advantage of the present invention to provide a practical method for improving the flavor stability of malt beverages.

It is another advantage of the present invention to provide an effective composition for improving the flavor stability of malt beverages

These and other features, aspects, and advantages of the present invention will become better understood upon consideration of the following detailed description, drawings, and appended claims.

### DESCRIPTION OF THE DRAWINGS

The following figures illustrate the effects of added hop products and two sulfites on the free radical formation during wort boiling measured by EPR. The hop products including hop pellets, CO2 extract (CO2X), hop solids, alpha-acids, beta-acids, hop oil fraction (HOF), and beta-rich fraction (a mixture of beta-acids and HOF) and two sulfites (potassium metasulfite, KMS, and sodium hydrosulfite, Thiox B) were added respectively to the first wort at 50-60° C. prior to the wort boiling. Each special wort with an added substance vs. a control containing no added substance was boiled to simulate the kettle boiling.

FIG. 1 is a graph illustrating EPR Intensity versus the wort samples taken at different temperatures while the wort was boiling. The free radical formation starts and increases significantly when the wort temperature reaches between 85° and 100° C. and rises with a prolonged heating. The worts containing hop products which do not contain alpha-acids (including hop solids, beta-acids, HOF and beta-rich) and two sulfites show no reducing effect and are similar to the control (the wort containing no hop additions) in terms of the free radical formation. In contrast, three hop products, hop pellets, CO₂ extract and alpha-acids, depress the free radical formation between 85°-100° C. in wort boiling and lower the radical intensity after an hour boiling. The alpha-acids are a common denominator in hop pellets, CO₂ extract and alpha-acids. It is suggesting that the alpha-acids may be the major components to interrupt the formation of free radical precursors during wort boiling.

In the brewing process, alpha-acids in hops and CO₂ extract are isomerized to iso-alpha-acids during wort boiling to give rise to the bitterness in beer. FIG. 2 is a graph showing EPR Intensity versus wort samples taken at different temperatures during wort boiling with iso-alpha-acids added before boiling versus a control wort wherein no compounds were added. The iso-alpha-acids show no reducing effect on the free radical formation.

FIG. 3 is a graph illustrating EPR Intensity versus samples taken at different temperatures for wort when hop pellets and CO extracts are added at 100° C. instead of before boiling versus a control wort wherein no compounds were added. The hop pellets and CO₂ extracts demonstrate clearly a reducing effect on the free radical formation during the wort boiling.

FIG. 4 is a graph showing EPR Intensity versus samples taken at different temperatures of wort having the hop CO₂ extract added at three levels prior to boiling versus a control wort wherein no compounds were added. It demonstrates that the hop CO₂ extract (most likely the alpha-acids) reduces or minimizes quantitatively the free radical precursors during wort boiling. EPR evidently identifies the reducing power of the hop products during the wort boiling.

FIG. 5 is a graph showing EPR intensity versus samples taken at different temperatures of wort having L-ascorbic acid (Vitamin C) added prior to boiling versus a control wort wherein no compounds were added. The L-ascorbic acid is one type of natural antioxidant. The L-ascorbic acid seems to have a negative effect on reducing the formation of free radical precursor before wort boiling. However, it shows some effect during one hour wort boiling, but it is not as effective as the hop CO₂ extract.

Adding hops during wort boiling is traditionally a means of extracting the water-soluble components from hops, in addition to isomerization of alpha-acids to iso-alpha-acids. A hop water extract was prepared by boiling water and hop pellets. In a similar manner, a hop solid water extract was prepared. In addition, a 95% ethanol extract was prepared by extracting hop solids with 95% ethanol. Subsequently, the recovered residue after 95% ethanol extraction was further fractionated with a 50% ethanol/water to produce a 50% ethanol extract. The oxidative staling activity of four extracts added in beer (containing no such hop components) were tested and measured for the lag time by EPR.

FIG. 6 is a graph illustrating EPR lag time arialysis for spiked draft beer samples versus a control draft beer wherein no such hop extract was added. The beer spiked with the 50% ethanol/water extract of hop solids extends the greatest lag time among the boiled water and the 95% ethanol extracts.

FIG. 7 is a graph illustrating EPR lag time analysis for spiked pasteurized beer samples versus a pasteurized beer wherein no hop extract was added. The beer spiked with the 50% ethanol/water extract of hop solids significantly increases the lag time more than other groups of spiked beers. EPR evidently identifies the presence of natural antioxidants in the 50% ethanol/water extract. Using a mixture of 50% ethanol and 50% water unexpectedly and effectively fractionates the most potent natural anti-oxidants from hop solids among the boiled water and the 95% ethanol extracts.

### DETAILED DESCRIPTION OF THE INVENTION

The present invention provides methods and compositions for improving the flavor stability of a fermented malt beverage. The methods and compositions reduce or eliminate stale off-flavors that develop during extended storage of fermented malt beverages, such as beer and ale. It is believed that the stale flavor or carbonyls flavor that occurs in stale beer arises from the free radical mediated oxidation of various constituents in beer. The characteristic odor and taste are believed to be caused by decomposition products from the free radical process. The present invention protects from heat damage or reduces the formation of free radical precursors during wort boiling and also reduces or eliminates the oxidative stale off flavor formation that occurs in fermented malt beverages by, among other things, reducing the amount and/or the formation of free radicals in the finished fermented malt beverage product.

In a first version of the invention, hop solids are extracted for example with a mixture of water and a C₁-C₆ monohydric or polyhydric alcohol to fractionate a hop solids extract enriched in natural antioxidants, and the resulting hop solids extract is added to wort to prepare fermented malt beverages. The natural antioxidants present in the hop solids extract reduce the formation of free radicals in the finished fermented malt beverage. The term “hop solids” as used herein means the solid hop residue obtained by extracting whole hops or hop pellets with a solvent such as hexane, carbon dioxide (liquid or supercritical), alcohol (e.g., >95% ethanol, methanol, or isopropyl alcohol), water, or the solid hop residue recovered after boiling whole hops or hop pellets in a brewing kettle.

Non-limiting examples of the C₁-C₆ monohydric or polyhydric alcohol used in the first version of the invention include: C₁-C₆ alkylene glycols such as ethylene glycol and propylene glycol; and C₁-C₆ alkanols, such as methanol, ethanol, propanol, butanol, pentanol, and hexanol. Preferably, the C₁-C₆ monohydric or polyhydric alcohol is a C₁-C₆ alkanol, and most preferably, the C₁-C₆ monohydric or polyhydric alcohol is ethanol.

The mixture of water and C₁-C₆ monohydric or polyhydric alcohol used in the first version of the invention to fractionate a hop solids extract may have various ratios of water and C₁-C₆ monohydric or polyhydric alcohol dependent upon the purity of the fraction required. The fraction can be used either before or after the fermentation. In one form, the mixture comprises 5% to 95% water by volume and 5% to 95% C₁-C₆ monohydric or polyhydric alcohol by volume. In another form, the mixture comprises 25% to 75% water by volume and 25% to 75% C₁-C₆ monohydric or polyhydric alcohol by volume. In yet another form, the mixture comprises 45% to 55% water by volume and 45% to 55% C₁-C₆ monohydric or polyhydric alcohol by volume. In an example embodiment, the mixture comprises 45% to 55% water by volume and 45% to 55% ethanol by volume. In another example embodiment, the mixture comprises 50% water by volume and 50% ethanol by volume. The use of a mixture comprising 50% water by volume and 50% ethanol by volume to create a hop solids extract is particularly advantageous as the resulting hop extract has very low levels of alpha-acids/iso-alpha-acids. The alpha-acids/iso-alpha-acids can lead to light instability in a fermented malt beverage and therefore, elimination of these compounds is of significant benefit. For a discussion of light instability in malt beverages, see U.S. Pat. No. 6,207,208, which is incorporated herein by reference.

In a second version of the invention, hop solids are extracted for example with a first mixture of water and a C₁-C₆ monohydric or polyhydric alcohol, hop solids are recovered from the first mixture containing very low levels of alpha-acids/iso-alpha-acids, the hop solids are extracted for example with a second mixture of water and a C₁-C₆ monohydric or polyhydric alcohol to create a hop solids extract, and the hop solids extract is added to a fermented malt beverage. The hop solids extract reduces the formation of free radicals in the finished fermented malt beverage which is also light stable.

Non-limiting examples of the C₁-C₆ monohydric or polyhydric alcohol used in the first mixture and the second mixture of the second version of the invention include: C₁-C₆ alkylene glycols such as ethylene glycol and propylene glycol; and C₁-C₆ alkanols, such as methanol, ethanol, propanol, butanol, pentanol, and hexanol. Preferably, the C₁-C₆ monohydric or polyhydric alcohol is a C₁-C₆ alkanol, and most preferably, the C₁-C₆ monohydric or polyhydric alcohol is ethanol.

The first mixture of water and C₁-C₆ monohydric or polyhydric alcohol used in the second version of the invention to extract the hop solids, may have various ratios of water and C₁-C₆ monohydric or polyhydric alcohol, in which water ratios are much lower. In one form, the first mixture comprises 0% to 15% water by volume and 85% to 100% C₁-C₆ monohydric or polyhydric alcohol by volume. In another form, the mixture comprises 5% water by volume and 95% C₁-C₆ monohydric or polyhydric alcohol by volume. In an example embodiment, the mixture comprises 0% to 1.5% water by volume and 85% to 100% ethanol by volume. In another example embodiment, the mixture comprises 5% water by volume and 95% ethanol by volume.

The second mixture of water and C₁-C₆ monohydric or polyhydric alcohol used in the second version of the invention to extract the hop solids may have various ratios of water and C₁-C₆ monohydric or polyhydric alcohol. In one form, the second mixture comprises 5% to 95% water by volume and 5% to 95% C₁-C₆ monohydric or polyhydric alcohol by volume. In another form, the second mixture comprises 25% to 75% water by volume and 25% to 75% C₁-C₆ monohydric or polyhydric alcohol by volume. In yet another form, the second mixture comprises 45% to 55% water by volume and 45% to 55% C₁-C₆ monohydric or polyhydric alcohol by volume. In an example embodiment, the second mixture comprises 45% to 55% water by volume and 45% to 55% ethanol by volume. In another example embodiment, the second mixture comprises 50% water by volume and 50% ethanol by volume. The use of a mixture comprising 50% water by volume and 50% ethanol by volume to create a hop solids extract is particularly advantageous as the resulting hop extract has very low levels of alpha-acids/iso-alpha-acids, which are known to cause light instability in malt beverages.

In a third version of the invention, hop solids are extracted for example with a first mixture of water and a C₁-C₆ monohydric or polyhydric alcohol, the extracted hop solids are recovered from the first mixture, the extracted hop solids are further extracted with a second mixture of water and a C₁-C₆ monohydric or polyhydric alcohol to create a hop solids extract, and the hop solids extract is added to wort to prepare fermented malt beverages. The hop solids extract reduces the formation of free radicals in the finished fermented malt beverage which is also light stable.

Non-limiting examples of the C₁-C₆ monohydric or polyhydric alcohol used in the first mixture and the second mixture of the third version of the invention include: C₁-C₆ alkylene glycols such as ethylene glycol and propylene glycol; and C₁-C₆ alkanols, such as methanol, ethanol, propanol, butanol, pentanol, and hexanol. Preferably, the C₁-C₆ monohydric or polyhydric alcohol is a C₁-C₆ alkanol, and most preferably, the C₁-C₆ monohydric or polyhydric alcohol is ethanol.

The first mixture of water and C₁-C₆ monohydric or polyhydric alcohol used in the third version of the invention to extract the hop solids may have various ratios of water and C₁-C₆ monohydric or polyhydric alcohol. In one form, the first mixture comprises 0% to 15% water by volume and 85% to 100% C₁-C₆ monohydric or polyhydric alcohol by volume. In another form, the mixture comprises 5% water by volume and 95% C₁-C₆ monohydric or polyhydric alcohol by volume. In an example embodiment, the mixture comprises 0% to 15% water by volume and 85% to 100% ethanol by volume. In another example embodiment, the mixture comprises 5% water by volume and 95% ethanol by volume.

The second mixture of water and C₁-C₆ monohydric or polyhydric alcohol used in the third version of the invention to extract the extracted hop solids may have various ratios of water and C₁-C₆ monohydric or polyhydric alcohol. In one form, the second mixture comprises 5% to 95% water by volume and 5% to 95% C₁-C₆ monohydric or polyhydric alcohol by volume. In another form, the second mixture comprises 25% to 75% water by volume and 25% to 75% C₁-C₆ monohydric or polyhydric alcohol by volume. In yet another form, the second mixture comprises 45% to 55% water by volume and 45% to 55% C₁-C₆ monohydric or polyhydric alcohol by volume. In an example embodiment, the second mixture comprises 45% to 55% water by volume and 45% to 55% ethanol by volume. In another example embodiment, the second mixture comprises 50% water by volume and 50% ethanol by volume. The use of a mixture comprising 50% water by volume and 50% ethanol by volume to create a hop solids extract is particularly advantageous as the resulting hop extract has very low levels of alpha-acids/iso-alpha-acids, which are known to cause light instability in malt beverages.

In a fourth version of the invention, hops, which may be whole hops or hop pellets, are extracted with a mixture of 25% to 75% water by volume and 25% to 75% of a C₁-C₆ monohydric or polyhydric alcohol by volume to create a hop extract. This new type of hop extract contains both alpha-acids and an enriched natural antioxidants and flavor precursor fraction. Adding this hop extract to wort, prior to or during boiling, the wort is boiled, and the wort is fermented to form a fermented malt beverage. The alpha-acids in the hop extract reduces the formation of free radicals precursor in the boiled wort, thereby reducing the amount of free radicals formation, and the natural antioxidants reduces the oxidation in the finished fermented malt beverage, thereby extending the shelf-life or flavor stability.

Non-limiting examples of the C₁-C₆ monohydric or polyhydric alcohol used in the fourth version of the invention include: C₁-C₆ alkylene glycols such as ethylene glycol and propylene glycol; and C₁-C₆ alkanols, such as methanol, ethanol, propanol, butanol, pentanol, and hexanol. Preferably, the C₁-C₆ monohydric or polyhydric alcohol is a C₁-C₆ alkanol, and most preferably, the C₁-C₆ monohydric or polyhydric alcohol is ethanol.

The mixture of water and C₁-C₆ monohydric or polyhydric alcohol used in the fourth version of the invention to create a new hop extract may have various ratios of water and C₁-C₆ monohydric or polyhydric alcohol. In one form, the mixture comprises 25% to 75% water by volume and 25% to 75% C₁-C₆ monohydric or polyhydric alcohol by volume. In yet another form, the mixture comprises 45% to 55% water by volume and 45% to 55% C₁-C₆ monohydric or polyhydric alcohol by volume. In an example embodiment, the mixture comprises 45% to 55% water by volume and 45% to 55% ethanol by volume. In another example embodiment, the mixture comprises 50% water by volume and 50% ethanol by volume. The use of a mixture comprising 50% water by volume and 50% ethanol by volume to create a new hop extract, in addition to the contribution of flavor and bitterness, is particularly advantageous as the resulting hop extract contains both alpha-acids which have demonstrated the reducing power of free radical formation during wort boiling, and enriched natural antioxidants to extend the shelf-life (the lag time) of the finished malt beverages.

### EXAMPLES

The following Examples have been presented in order to further illustrate the invention and are not intended to limit the invention in any way.

### Example 1

Experiments were performed to determine whether the heat of wort boiling damages wort by generating free radicals or free radical precursors, which mediate the oxidation of various constituents in beer. An experimental apparatus was used to simulate wort boiling in a brewing kettle. The boiling of wort was undertaken in a three-necked 500 milliliter round bottom flask equipped with a condenser, a magnetic bar and a thermometer. First wort was collected at the Milwaukee, Wis., USA brewery of the SAB Miller Brewing Company. Individual two hundred milliliter portions of the wort were heated up to boiling (100° C.) and then boiled for 1 hour in the flask. At various temperatures during the heating and boiling process, samples were collected from the flask and analyzed for free radical levels using a forced auto-oxidation test and electron paramagnetic resonance (EPR) spin trapping techniques. Each sample was force-oxidized by heating in a 60° C. water bath and air for a period of 3 hours and the level of free radicals was monitored. The free radical level versus time was plotted. From the plot, a EPR intensity at T=120 minutes is taken as the standard value of free radical formation for the wort. These techniques are described in U.S. Pat. No. 5,811,305 and in “Shelf Life Analysis of Beer Using an Automated Lag-Time EPR System”, Spectroscopy 16(12), pgs. 17-19, December 2001. Instrumentation for performing EPR spin trapping is commercially available from Bruker Instruments Inc., Billerica, Mass., USA and Bruker Analytik GmbH, Rheinstetten, Germany. The free radical levels correlate to EPR Intensity in the EPR instrumentation. Samples were collected from the flask at 70° C., 85° C., 100° C., and after boiling for 1 hour at 100° C. and analyzed for free radical level.

### Example 1.1

In a first group of nine experimental test runs, each of the following compounds was individually added during the heating of wort in the flask when the wort was between 50° C. and 60° C.: (1) Galena hop pellets at 1000 ppm; (2) Galena hop solids, that is, the solid residue remaining after CO₂ extraction of Galena hops, at 1300 & 2000 ppm; (3) the CO₂ extract of Galena hops at 110 ppm (labeled CO2X); (4) alpha acids at 120 ppm; (5) beta-acids at 72 ppm; (6) hop oil fraction (HOF), that is, the hop oils remaining after alpha-acids and beta-acids are removed from the CO₂ hop extract, at 50-100 ppm; (7) beta-rich hop fraction, that is a hop oil fraction having beta-acids, at 100 ppm; (8) KMS, potassium metabisulfite, a sulfite antioxidant commercially available from Brewer Wholesale Supply at 50 ppm; and (9) Thiox B, sodium hydrosulfite, a brewers antioxidant commercially available from Brewers Wholesale Supply, Newport, R.I. at 50 ppm. The above hop products and derivatives are well known in the art and are available, for example, from SAB Miller Brewing Company (Watertown Hops Company), John I. Haas, Inc., S. S. Steiner, Inc., and Kalsec (Kalamazoo Holdings, Inc.).

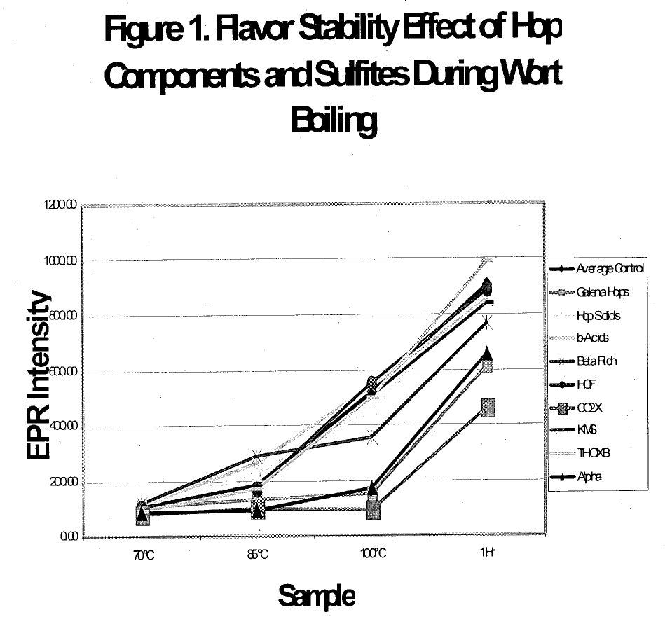

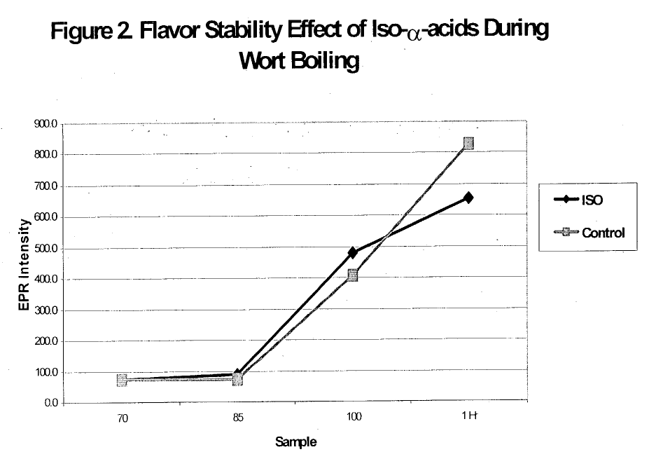

In the first group of nine test runs, each of the nine compounds was added to the flask when the wort was between 50° C. and 60° C. After the wort reached 70° C., a first sample was collected from the flask and analyzed for free radical levels by measuring EPR Intensity in the EPR instrumentation. When the wort reached 85° C., a second sample was collected from the flask and analyzed for free radical levels. When the wort reached 100° C., a third sample was collected from the flask and analyzed for free radical levels. After boiling for 1 hour at 100° C., a fourth sample was collected from the flask and analyzed for free radical levels. The EPR Intensity signal at 120 minutes was then plotted versus the sample at the temperature of sample collection for the wort having each of the nine compounds and a control wort wherein no compounds were added. The graph is included as FIG. 1.

### Example 1.2

In a second group of test runs, iso-alpha acids were added to the flask at 113 ppm when the wort was between 50° C. and 60° C. After the wort reached 70° C., a first sample was collected from the flask and analyzed for free radical levels by measuring EPR Intensity in the EPR instrumentation. When the wort reached 85° C., a second sample was collected from the flask and analyzed for free radical levels. When the wort reached 100° C., a third sample was collected from the flask and analyzed for free radical levels. After boiling for 1 hour at 100° C., a fourth sample was collected from the flask and analyzed for free radical levels. The EPR Intensity signal at 120 minutes was then plotted versus the sample at the temperature of sample collection for the wort having iso-alpha-acids and a control wort wherein no compounds were added. The graph is included as FIG. 2.

### Example 1.3

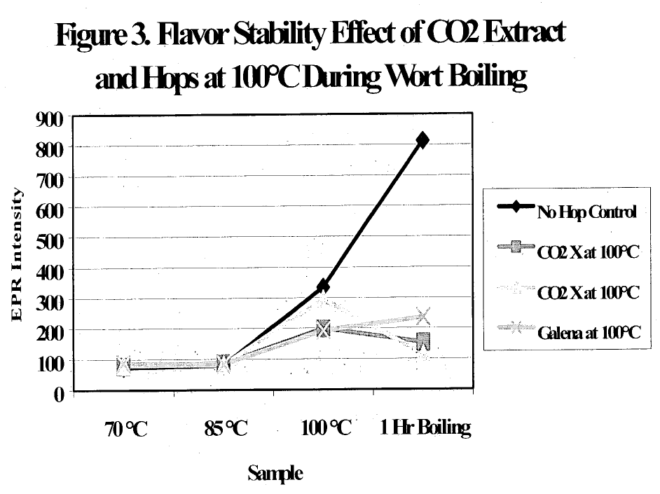

In a third group of experimental test runs, Galena hop pellets at 1000 ppm and two CO₂ extracts of Galena hops at 220 ppm were added to the flask, respectively, when the wort was boiling. During the tests, a first sample was collected from the flask when the wort reached 70° C. and analyzed for free radical levels by measuring EPR Intensity in the EPR instrumentation. When the wort reached 85° C. a second sample was collected from the flask and analyzed for free radical levels. When the wort reached 100° C., a third sample was collected from the flask and analyzed for free radical levels. The hop samples were then added to the flask. After boiling for 1 hour at 100° C. (1 hour after the compound addition), a fourth sample was collected from the flask and analyzed for free radical levels. The EPR Intensity signal at 120 minutes was then plotted versus the sample at the temperature of sample collection for the wort having Galena hop pellets at 1000 ppm, the wort having the CO₂ extract of Galena hops at 220 ppm and a control wort wherein no compounds were added. The graph is included as FIG. 3.

### Example 1.4

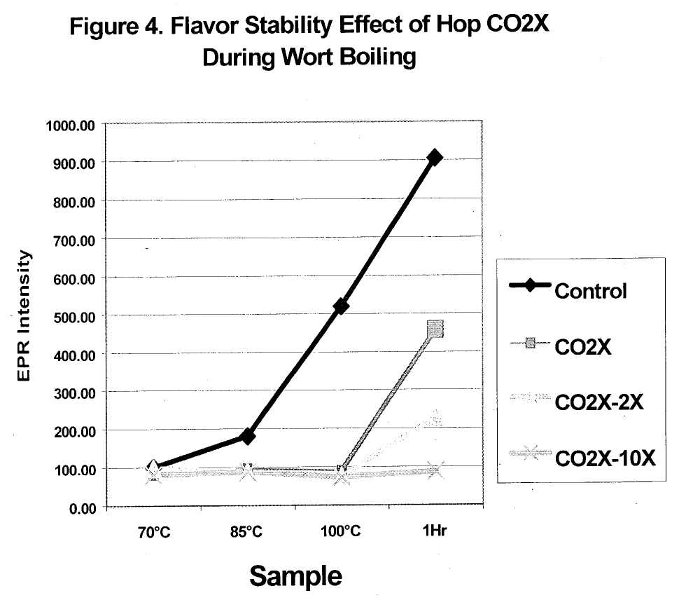

In a fourth group of experimental test runs, the CO₂ extract of Galena hops was added to the flask when the wort was heated about 50-60° C. at three different levels 110 ppm, 220 ppm, 1100 ppm, respectively (labeled CO2X, CO2X-2X, and CO2X-10×in FIG. 4). The second level was twice the first level and the third level was five times the second level. During the tests, a first sample was collected from the flask when the wort reached 70° C. and analyzed for free radical levels by measuring EPR Intensity in the EPR instrumentation. When the wort reached 85° C., a second sample was collected from the flask and analyzed for free radical levels. When the wort reached 100° C., a third sample was collected from the flask and analyzed for free radical levels. After boiling for 1 hour at 100° C., a fourth sample was collected from the flask and analyzed for free radical levels. The EPR Intensity signal at 120 minutes was then plotted versus the sample at the temperature of sample collection for the worts having the CO₂ extract of Galena hops at three levels and a control wort wherein no compounds were added. The graph is included as FIG. 4.

### Example 1.5

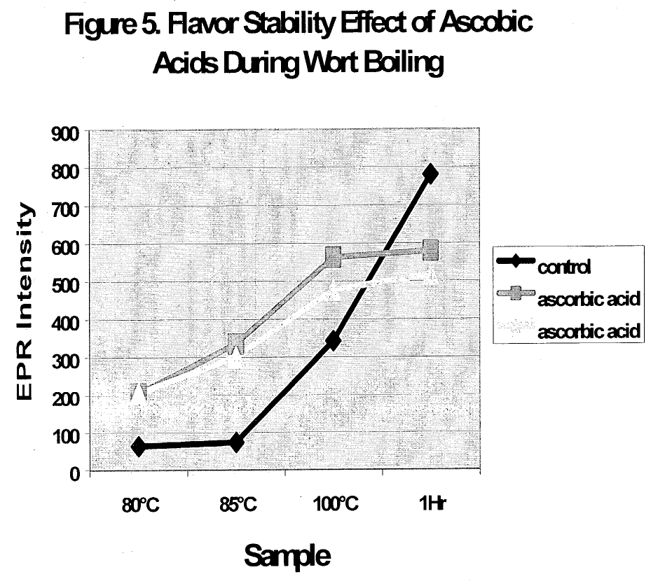

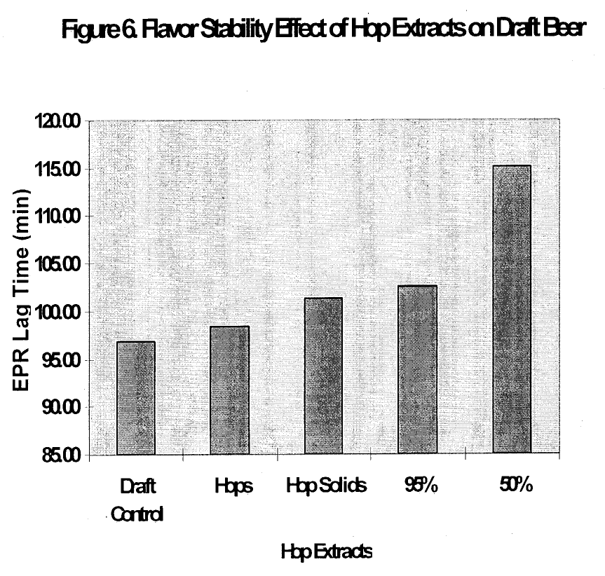

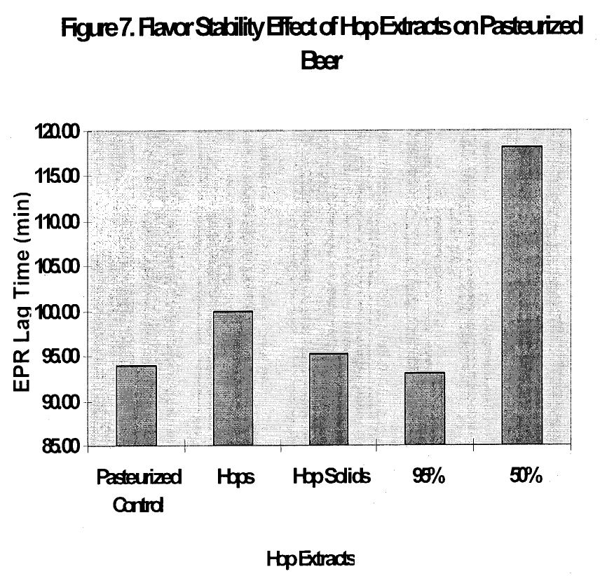

In a fifth group of experimental test runs, L-ascorbic acid was added to the flask when the wort was heated about 50-60° C. at a level of 275 ppm. During the tests, a first sample was collected from the flask when the wort reached 70° C. and analyzed for free radical levels by measuring EPR Intensity in the EPR instrumentation. When the wort reached 85° C., a second sample was collected from the flask and analyzed for free radical levels. When the wort reached 100° C., a third sample was collected from the flask and analyzed for free radical levels. After boiling for 1 hour at 100° C., a fourth sample was collected from the flask and analyzed for free radical levels. The EPR Intensity signal at 120 minutes was then plotted versus the sample at the temperature of sample collection for the wort having the L-ascorbic acid and a control wort wherein no compounds were added. The graph is included as FIG. 5.

### Analysis of Examples 1-1.5

FIGS. 1 to 5 indicate that alpha acids, Galena hop pellets and the CO₂ extract of Galena hops most significantly reduce the formation of free radical precursors (as measured by the EPR technique) during wort boiling. The common denominator of these three hop products is alpha acids. In contrast, those that do not contain alpha-acids such as the Galena hop solids, the beta-acids, the hop oil fraction (HOF), the beta-rich hop fraction, the antioxidants (KMS and Thiox B) and the L-ascorbic acid appear to have little effect in reducing the generation of free radical precursors. FIG. 2 shows that iso-alpha acids do not effectively reduce the generation of free radicals precursors. The alpha acids are generally isomerized into iso-alpha acids during wort boiling. FIG. 3 indicates that Galena hop pellets and the CO₂ extract of Galena hops can significantly reduce the generation of free radical precursors even when added after the wort is boiling. FIG. 4 shows that increased levels of the CO₂ extract of Galena hops can even further reduce the generation of free radical precursors in the wort. In other words, the free radical precursor formation during wort boiling is proportional reduced to the amount of added CO₂ hop extract. Thus, alpha acids, Galena hop pellets and the CO₂ extract of Galena hops can reduce the generation of free radical precursors in boiling wort, and it may be of benefit to add alpha-acids, hops, hop pellets, or CO₂ hop extract before the wort reaches 85° C. or after the wort is boiling, but preferably before the wort reaches 85° C. The reduction of free radical precursors in wort can reduce the potential of the oxidation of various constituents in beer, thereby reducing the development of stale off-flavors in beer.

### Example 2

Four different water and water/ethanol hop extracts were obtained as follows: (1) a Galena hops water extract was obtained by boiling 1.2 grams of Galena hop pellets in 20 milliliters of water for 1 hour and reducing to 10 milliliters, filtering the mixture, and retaining the filtrate; (2) a Galena hop solids—water extract was obtained by boiling 1.0 grams of ground hop solids (the solid residue remaining after CO₂ extraction of Galena hops) in 20 milliliters of water for 1 hour and reducing to 10 milliliters, filtering the mixture, and retaining the filtrate; (3) a Galena hop solids-95% ethanol extract was obtained by agitation of 100 grams of ground hop solids (the solid residue remaining after CO₂ extraction of Galena hops) in 150 milliliters of a 95% ethanol/5% water (v/v) mixture for 1 hour, filtering the mixture, and retaining the filtrate; and (4) a Galena hop solids —50% ethanol extract was obtained by mixing the total recovered residues after 95% ethanol extracted in 100 milliliters of a 50% ethanol/50% water (v/v) mixture for 1 hour, filtering the mixture, and retaining the filtrate.

Two 0.5 milliliters of each of the two water extracts (#1 and #2) prepared above were added to 25 milliliter samples of Cold-filtered™ draft beer and pasteurized beer, respectively. A mixture of 0.075 milliliters of 95% ethanol solution (#3) prepared above and 0.43 ml water was added to 25 milliliters samples of draft beer and pasteurized beer, respectively. A mixture of 0.05 milliliters of 50% ethanol solution (#4) prepared above and 0.45 ml water was added to 25 milliliters samples of draft beer and pasteurized beer, respectively. The over-added beers were force-oxidized by heating at 60° C. in air for three hours and samples were analyzed by EPR during the forced oxidation. Respective control (no extract, but 0.5 milliliters added water) beers were also heated at 60° C. in air for three 3 hours and samples were monitored by EPR during the forced oxidation. The EPR Intensity for the samples was measured in EPR instrumentation. The EPR lag time analysis was then used to determine the anti-oxidation potentials or corresponding shelf-life for the over-added/beer samples. EPR lag time analytical techniques are described in U.S. Pat. No. 5,811,305 and in “Shelf Life Analysis of Beer Using an Automated Lag-Time EPR System”, Spectroscopy 16(12), pgs. 17-19, December 2001. In short, the longer the lag time, the greater the anti-oxidation activity or oxygen resistance of the fermented alcoholic beverage, thus making it possible to evaluate the fermented alcoholic beverage as having good flavor stability. The results of the EPR lag time analysis for the draft beer/extract mixtures were plotted and are shown in Figure 6. Likewise, the results of the EPR lag time analysis for the pasteurized beer/extract mixtures were plotted and are shown in FIG. 7.

### Analysis of Example 2

Looking first at FIG. 6, it can be seen that: (1) the control beer (no extract) had the lowest lag time and therefore would correspond to the lowest flavor stability; (2) the mixture of beer and the hops-water extract prepared in Example 2 (labeled “Hops” in FIG. 6) had a greater lag time than the control and therefore would be correspond to a greater flavor stability than the control; (3) the mixture of beer and the hop solids-water extract prepared in Example 2 (labeled “Hop Solids” in FIG. 6) had an even greater lag time than the control and therefore would correspond to an even greater flavor stability than the control; (4) the mixture of beer and the hop solids-95% ethanol extract prepared in Example 2 (labeled “95%” in FIG. 6) had an even greater lag time than the control and therefore would correspond to an even greater flavor stability than the control; and

(5) the mixture of beer and the hop solids-50% ethanol extract prepared in Example 2 (labeled “50%” in FIG. 6) had the greatest lag time among the control and others and therefore would correspond to the most flavor stability or longest shelf-life among the control and others.

Looking next at FIG. 7, it can be seen that: (1) the control beer (no extract), the mixture of beer and the hops-water extract prepared in Example 2 (labeled “Hops” in FIG. 7), the mixture of beer and the hop solids-water extract prepared in Example 2 (labeled “Hop Solids” in FIG. 7), and the mixture of beer and the hop solids-95% ethanol extract prepared in Example 2 (labeled “95%”in FIG. 7) all had about the same lag time with no effect; and (2) the mixture of beer and the hop solids-50% ethanol extract prepared in Example 2 (labeled “50%” in FIG. 7) had the greatest lag time among the control and other mixtures and therefore would correspond to having a greatest flavor stability among the control and other mixtures.

Thus, there have been provided methods and compositions for reducing or eliminating stale off-flavors that develop during extended storage of malt beverages. The present invention reduces or eliminates the stale off flavors that occur in fermented malt beverages by, among other things, reducing the amount and/or the formation of free radicals in the finished fermented malt beverage product.

Although the present invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

### INDUSTRIAL APPLICABILITY

The methods and compositions taught herein are useful in the preparation of brewed malt beverages, such as beer and ale, beverages, and food stuffs and serve to reduce stale off-flavors that develop during extended storage of fermented malt beverages, beverage, and food stuffs. It also apply to other products and processes in which degradation is initiated by free radical mechanisms.

What is claimed is:

1. A method for improving the flavor stability of a fermented malt beverage produced from a fermentable medium, the method comprising:
extracting hop solids to create a hop solids extract comprising enriched natural antioxidants;
adding the hop solids extract to a fermentable medium; and
thereafter fermenting the medium to prepare a fermented malt beverage.

2. The method of claim 1 wherein:
the hop solids are extracted with a mixture of water and a C₁-C₆ monohydric or polyhydric alcohol.

3. The method of claim 2 wherein:
the C₁-C₆ monohydric or polyhydric alcohol is ethanol.

4. The method of claim 2 wherein:
the mixture comprises 5% to 95% water by volume and 5% to 95% C₁-C₆ monohydric or polyhydric alcohol by volume.

5. The method of claim 2 wherein:
the mixture comprises 25% to 75% water by volume and 25% to 75% C₁-C₆ monohydric or polyhydric alcohol by volume.

6. The method of claim 2 wherein:
the mixture comprises 45% to 55% water by volume and 45% to 55% C₁-C₆ monohydric or polyhydric alcohol by volume.

7. The method of claim 2 wherein:
the mixture comprises 45% to 55% water by volume and 45% to 55% ethanol by volume.

8. The method of claim 1 wherein:
the fermented malt beverage is beer.

9. The method of claim 1 wherein:
the fermentable medium is wort; and
the hop solids extract is added to the wort before boiling of the wort.

10. The method of claim 1 wherein:
the fermentable medium is wort; and
the hop solids extract is added to the wort after the wort has been heated to the boiling point of the wort.

11. The method of claim 1 wherein:
the fermentable medium is wort;
the hop solids extract is added to the wort after the wort has been heated to the boiling point of the wort; and
the wort is boiled for a period of time after addition of the hop solids extract.

12. A method for improving the flavor stability of a fermented malt beverage produced from a fermentable medium, the method comprising:
extracting hop solids with a solvent comprising a C₁-C₆ monohydric or polyhydric alcohol;
recovering hop solids from the solvent;
extracting the recovered hop solids with a mixture comprising water and a C₁-C₆ monohydric or polyhydric alcohol to create a hop solids extract comprising enriched natural antioxidants;
adding the hop solids extract to a fermentable medium; and
thereafter fermenting the medium to prepare a fermented malt beverage.

13. The method of claim 12 wherein:
the solvent comprises 0% to 15% water by volume and 85% to 100% of a C₁-C₆ monohydric or polyhydric alcohol by volume.

14. The method of claim 12 wherein:
the solvent comprises 0% to 15% water by volume and 85% to 100% of ethanol by volume.

15. The method of claim 12 wherein:
the solvent comprises 5% water by volume and 95% ethanol by volume.

16. The method of claim 12 wherein:
the mixture comprises 5% to 95% water by volume and 5% to 95% C₁-C₆ monohydric or polyhydric alcohol by volume.

17. The method of claim 12 wherein:
the mixture comprises 25% to 75% water by volume and 25% to 75% C₁-C₆ monohydric or polyhydric alcohol by volume.

18. The method of claim 12 wherein:
the mixture comprises 45% to 55% water by volume and 45% to 55% C₁-C₆ monohydric or polyhydric alcohol by volume.

19. The method of claim 12 wherein:
the mixture comprises 45% to 55% water by volume and 45% to 55% ethanol by volume.

20. The method of claim 12 wherein:
the solvent comprises 0% to 15% water by volume and 85% to 100% of ethanol by volume, and
the mixture comprises 45% to 55% water by volume and 45% to 55% ethanol by volume.

21. The method of claim 12 wherein:
the fermented malt beverage is beer.

22. The method of claim 12 wherein:
the fermentable medium is wort; and
the hop solids extract is added to the wort boiling of the wort.

23. The method of claim 12 wherein:
the fermentable medium is wort; and
the hop solids extract is added to cold wort prior to the fermentation to make a fermented malt beverage.

24. The method of claim 12 wherein:
the fermentable medium is wort;
the hop solids extract is added after the fermentation to the finished malt beverage product.

25. A method for improving the flavor stability of a fermented malt beverage produced from a fermentable medium, the method comprising:
extracting hops with a mixture comprising 25% to 75% water by volume and 25% to 75% of a C₁-C₆ monohydric or polyhydric alcohol by volume to create a hop extract;
adding the hop extract to a fermentable medium; and
thereafter fermenting the medium to prepare a fermented malt beverage.

31. The method of claim 25 wherein:
the mixture comprises 45% to 55% water by volume and 45% to 55% C₁-C₆ monohydric or polyhydric alcohol by volume.

32. The method of claim 25 wherein:
the mixture comprises 25% to 75% water by volume and 25% to 75% ethanol by volume.

33. The method of claim 25 wherein:
the mixture comprises 45% to 55% water by volume and 45% to 55% ethanol by volume.

34. The method, of claim 25 wherein:
the fermentable medium is wort; and
the hop extract is added to the wort before boiling of the wort.

35. The method of claim 25 wherein:
the fermentable medium is wort; and
the hop extract is added to the wort after the wort has been heated to the boiling point of the wort.

36. The method of claim 25 wherein:
the fermentable medium is wort;
the hop extract is added to the wort after the wort has been heated to the boiling point of the wort; and
the wort is boiled for a period of time after addition of the hop solids extract.

37. A method for improving the flavor stability of a fermented malt beverage, the method comprising:
introducing an additive consisting essentially of alpha acids and/or alpha acid derivatives into a wort; and
thereafter fermenting the wort to prepare a fermented malt beverage.

38. The method of claim 37 wherein:
the additive is introduced into the wort before boiling of the wort.

39. The method of claim 37 wherein:
the additive is introduced into the wort after the wort has been heated to the boiling point of the wort.

40. The method of claim 37 wherein:
the additive is introduced into the wort after the wort has been heated to the boiling point of the wort; and
the wort is boiled for a period of time after the additive is introduced into the wort.

41. A method for reducing the oxidative staling of a food or beverage, the method comprising:
extracting hop solids with a solvent comprising a C₁-C₆ monohydric or polyhydric alcohol;
recovering hop solids from the solvent;
extracting the recovered hop solids with a mixture comprising water and a C₁-C₆ monohydric or polyhydric alcohol to create a hop solids extract comprising enriched natural antioxidants; and
adding the hop solids extract to a food or beverage.

42. The method of claim 41 wherein:
the solvent comprises 0% to 15% water by volume and 85% to 100% of a C₁-C₆ monohydric or polyhydric alcohol by volume.

43. The method of claim 41 wherein:
the solvent comprises 0% to 15% water by volume and 85% to 100% of ethanol by volume.

44. The method of claim 41 wherein:
the solvent comprises 5% water by volume and 95% ethanol by volume.

45. The method of claim 41 wherein:
the mixture comprises 5% to 95% water by volume and 5% to 95% C₁-C₆ monohydric or polyhydric alcohol by volume.

46. The method of claim 41 wherein:
the mixture comprises 25% to 75% water by volume and 25% to 75% C₁-C₆ monohydric or polyhydric alcohol by volume.

47. The method of claim 41 wherein:
the mixture comprises 45% to 55% water by volume and 45% to 55% C₁-C₆ monohydric or polyhydric alcohol by volume.

48. The method of claim 41 wherein:
the mixture comprises 45% to 55% water by volume and 45% to 55% ethanol by volume.

49. The method of claim 41 wherein:
the solvent comprises 0% to 15% water by volume and 85% to 100% of ethanol by volume, and
the mixture comprises 45% to 55% water by volume and 45% to 55% ethanol by volume.

50. A method for reducing the oxidative degradation of a cosmetic, the method comprising:
extracting hop solids with a solvent comprising a C₁-C₆ monohydric or polyhydric alcohol;
recovering hop solids from the solvent;
extracting the recovered hop solids with a mixture comprising water and a C₁-C₆ monohydric or polyhydric alcohol to create a hop solids extract comprising enriched natural antioxidants; and
adding the hop solids extract to a cosmetic.

51. The method of claim 50 wherein:
the solvent comprises 0% to 15% water by volume and 85% to 100% of a C₁-C₆ monohydric or polyhydric alcohol by volume.

52. The method of claim 50 wherein:
the solvent comprises 0% to 15% water by volume and 85% to 100% of ethanol by volume.

53. The method of claim 50 wherein:
the solvent comprises 5% water by volume and 95% ethanol by volume.

54. The method of claim 50 wherein:
the mixture comprises 5% to 95% water by volume and 5% to 95% C₁-C₆ monohydric or polyhydric alcohol by volume.

55. The method of claim 50 wherein:
the mixture comprises 25% to 75% water by volume and 25% to 75% C₁-C₆ monohydric or polyhydric alcohol by volume.

56. The method of claim 50 wherein:
the mixture comprises 45% to 55% water by volume and 45% to 55% C₁-C₆ monohydric or polyhydric alcohol by volume.

57. The method of claim 50 wherein:
the mixture comprises 45% to 55% water by volume and 45% to 55% ethanol by volume.

58. The method of claim 50 wherein:
the solvent comprises 0% to 15% water by volume and 85% to 100% of ethanol by volume, and
the mixture comprises 45% to 55% water by volume and 45% to 55% ethanol by volume.
